(19) United States
(12) Patent Application Publication
(10) Pub. No.: US 2009/0165017 A1
(43) Pub. Date: Jun. 25, 2009

(54) STATELESS PROPORTIONALLY CONSISTENT ADDRESSING

(75) Inventors: Ghousuddin Syed, Richardson, TX (US); Omar Syed, Murphy, TX (US); Karl Juhnke, Garland, TX (US); Mark Ray Lee, Richardson, TX (US); Justin Madison, Garland, TX (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/963,937

(22) Filed: Dec. 24, 2007

(51) Int. Cl. G06F 13/00

(52) U.S. Cl. 719/311

(57) ABSTRACT

A system and method for the delivery of a portion of a library of data to an end user. The system includes a plurality of data servers and at least one gateway server operatively connected to the end user. When the gateway server receives request from the end user for delivery of at least a portion of the library of data, the gateway server selects one of the plurality of data servers using a stateless addressing method and transmits instructions to the end user which enable the end user to issue a second request to the selected data servers for delivery the data to the end user. When the selected data server receives the second request, the server transmits the requested data to the end user.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

A variety of audio and video files are available from commercial providers on the Internet. Such providers typically have a large number of media servers available to serve media content to end users. Ideally, requests for media content serviced by a provider should be uniformly distributed across available media servers. One known method of achieving such a result is to pass requests for access through a gateway server.

In such a scenario, the primary responsibility of the gateway server is to balance the load among media servers. The gateway server can secondarily attempt to improve media server caching by assigning each media server to only a portion of the entire content library to a specific server. The fewer files a media server serves to end users, the more likely any given file will be in the server's cache at any given time, and the less often the media server must retrieve files from permanent storage.

### SUMMARY OF THE INVENTION

In one embodiment, the invention is directed to a system for the delivery of data to an end user. The system contains a library of data stored on a storage device, a plurality of data servers connected to the storage device and to the end user, and at least one gateway server operatively connected to the end user. The gateway server is adapted to receive a first request from the end user for delivery of at least a portion of the library of data, to select one of the plurality of data servers to deliver the data to the end user using a stateless addressing method, and to transmit instructions to the end user to enable the end user to issue a second request to the selected data server for delivery of the data. Each of the plurality of data servers is capable of receiving the second request for delivery of the data from the end user and transmitting the data to the end user.

In another embodiment, the invention is directed to a method for the delivery of at least a portion of a library of data to an end user, including the steps of receiving a request from the end user for delivery of data, selecting one of a plurality of data servers using a stateless addressing method, and transmitting the data to the end user using the selected data server.

In yet another embodiment, the invention is directed to a computer-readable medium having computer-executable instructions for a method for delivery of at least a portion of a library of data to an end user, including the steps of receiving a request from the end user for delivery of data, selecting one of a plurality of data servers using a stateless addressing method, and transmitting the data to the end user using the selected data server.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of a system for delivering media or other content to an end user system.

FIG. 2 illustrates one embodiment of a process 1000 for an end-user to access streaming media or other content from a provider with a streaming center such as that illustrated in FIG. 1.

FIG. 3 illustrates one embodiment of how a pool of five media or other types of data servers can be assigned to a unit interval mapped to an integer range of 0 to +80,000.

FIG. 4 illustrates one embodiment of a method for a gateway server to locate a media server to service a request for data.

FIG. 5 illustrates one embodiment of a method for a gateway server to a consistent server list for popular files.

### DETAILED DESCRIPTION

The present invention is described below with reference to block diagrams and operational illustrations of methods and devices to deliver content, such as streaming media, to end users. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the illustrations. For example, two blocks shown in succession can in fact be executed substantially concurrently or the blocks can sometimes be executed in the reverse order, depending upon the functionality or acts involved.

For the purposes of this disclosure the term “server” should be understood to refer to a service point which provides processing, database, and communication facilities. ]3y way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the terms “data”, “media”, “content”, “clip”, and “file” should be understood to refer to binary data which contains content which can be interest to an end user. By way of example, and not limitation, the term “data”, “media”, “content”, “clip”, and “file” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be further encrypted, compressed, and/or can contained embedded metadata.

For the purposes of this disclosure a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules.

Reference will now be made in detail to illustrative embodiments of the present invention, examples of which are shown in the accompanying drawings.

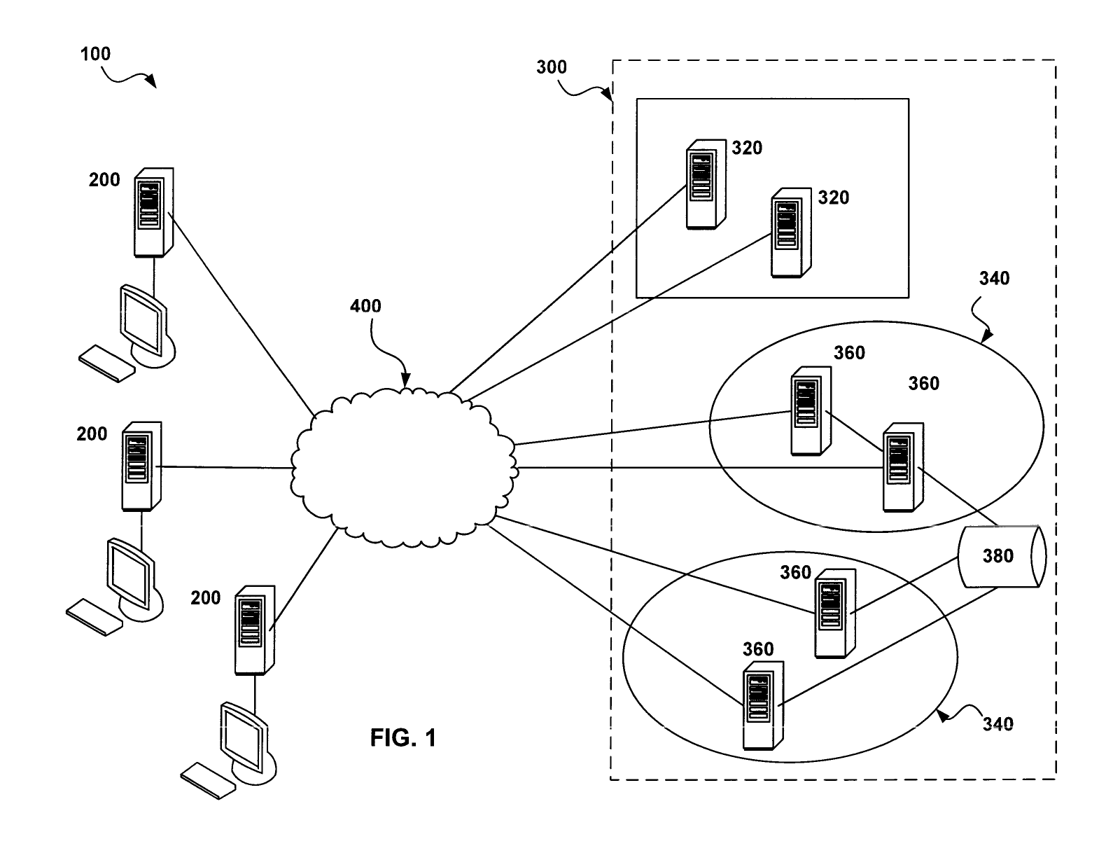

FIG. 1 illustrates one embodiment of a physical system 100 for delivering streaming media or other content to an end user. A streaming center 300, which can be owned and operated by a single data provider or can be operated jointly by cooperating providers, includes one or more gateway servers 320 and one or more pools 340 of one or media servers 360 which have access to one or more content libraries on permanent storage 380. In the illustrated embodiment, the content library 380 is shown within streaming center 300, however, content library can also be located remotely at a site owned and operated by a partner of the provider.

The gateway servers 320 are capable of receiving requests for content from an end user and of creating and transmitting instructions to a requesting end user to allow the end user to access the content through media servers 360. Media servers 360 are capable of retrieving content from the content library 380, storing such content in their internal cache, and of transmitting the content to end user systems in response to requests for the content from end user systems.

End user systems 200 have connectivity to the gateway servers 320 and the media servers 340 through an external network 400, for example, the Internet. The end user systems 200 are capable of transmitting a request for content to a gateway server 320, and of receiving instructions from the gateway server for accessing content on a media server. The end user systems are farther capable of using instructions received from a gateway server 320 to transmit a request for content to a media server 360, and of receiving and processing media or other content received from a media server.

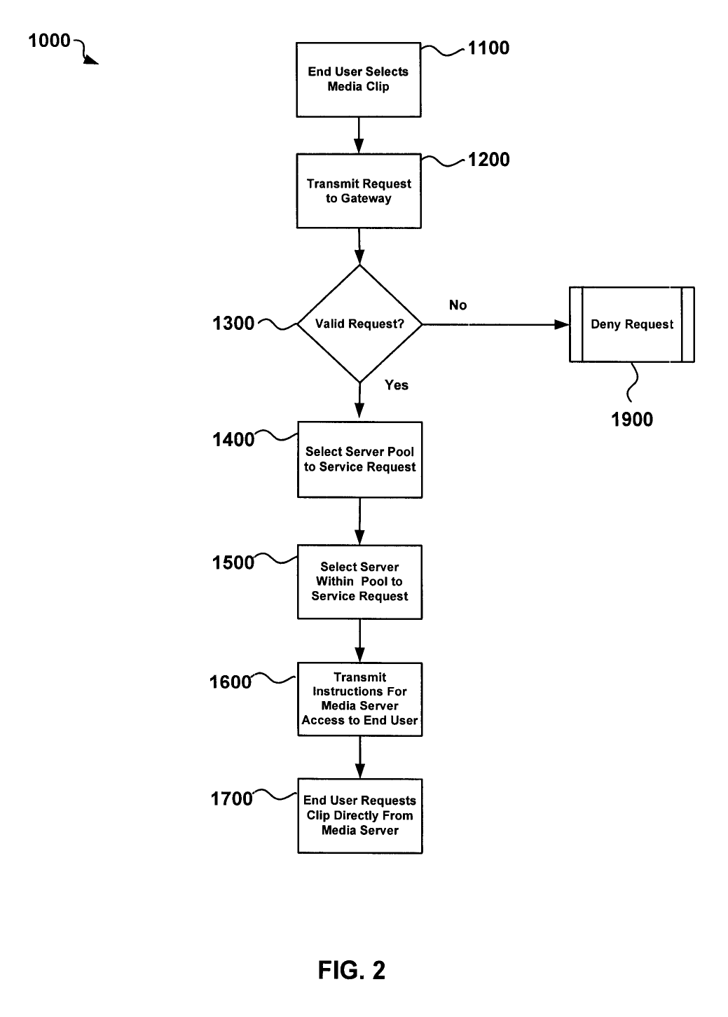

FIG. 2 illustrates one embodiment of a high-level process 1000 for an end-user to access streaming media or other content from a provider with a streaming center such as that illustrated in FIG. 1. An end user first selects a media clip 1100, for example, by clicking on a link in a third-party web page. Selecting the media clip causes a request f:or access to the clip to be transmitted 1200 to a gateway server. The gateway server validates the request 1300, for example, by determining if the requesting end user has sufficient authorization to access the requested clip. If the request is not valid, it is denied 1900.

If the request is valid, the gateway server selects a media server pool 1400 to service the request, selects a specific media server within the server pool to service the request 1500, and transmits instructions 1600, for example, a direct media server URL, to the requesting end user system to enable the end user to access the content on the selected media server. The end user system then uses the instructions to request the media clip directly from the media server 1700, which then transmit, the media clip directly to the end user.

Caching on the media servers, and ultimately, the performance of the system as a whole, can be improved by (1) consistently assigning specific files to the same server for multiple requests over a period of time, and (2) balancing transmission loads among servers within a server pool. One method to substantially achieve such a result is to assign files to servers within a server pool using a stateless addressing method. A method can be said to stateless if, for a specific file, the same media server is selected for every request that is received for access to that file by any gateway server.

In one embodiment, a stateless addressing method which consistently assigns specific files to the same server for multiple requests over a period of time can be implemented using a filename and a list of currently available servers as input and a server selected from the list of currently available servers as an output. Maintaining, a catalog of media resources among gateway servers is not necessary. The same input always produces the same output, so two different gateway servers, without communicating to each other, will address the same file to the same media server within a pool.

A stateless addressing method embodying the properties discussed above can be based on a consistent hashing algorithm, for example, an implementation based on the standard C pseudo-random number generator. In one embodiment, each file hosted by a pool of a media server can be given a unique numerical identifier as part of the filename, for example 43050217.flv. This number can then be used as the seed for a pseudo-random number generator which generates an arbitrarily-long, deterministic sequence of numbers, uniformly scattered in the unit interval of the random number generator (i.e. the range of possible values). In one embodiment, the pseudo-random number generator can be implemented as an integer function (as opposed to, for example, floating point) to increase the speed of the execution of the generator.

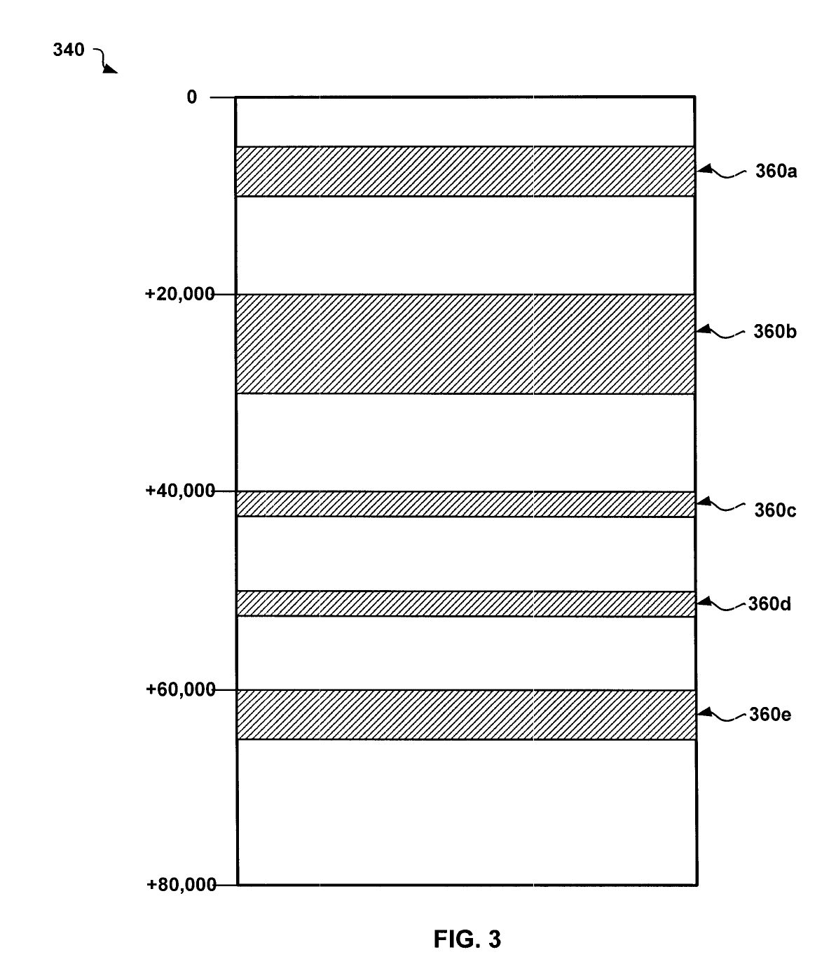

When a media server enters a server pool, it is assigned a segment of the unit interval that does not overlap with any other server's segment. To allow for addition of future media servers with minimal impact, servers within a pool can be assigned to segments which typically cover only 1% to 25% of the unit interval, depending on anticipated future growth. Wdhere growth is expected to be significant, the percentage can be lower, where little growth is expected, the percentage can approach 100%. The net result can be that a large portion of the unit interval that is not covered by any server. FIG. 3 illustrates one embodiment of how a pool 340 of five media servers 360a-360e can be assigned to a unit interval mapped to an integer range of 0 to +80,000. The integer range of 0 to 80,000 is purely exemplary, and can be a larger or smaller in actual practice. In this case, the unit interval is 25% utilized.

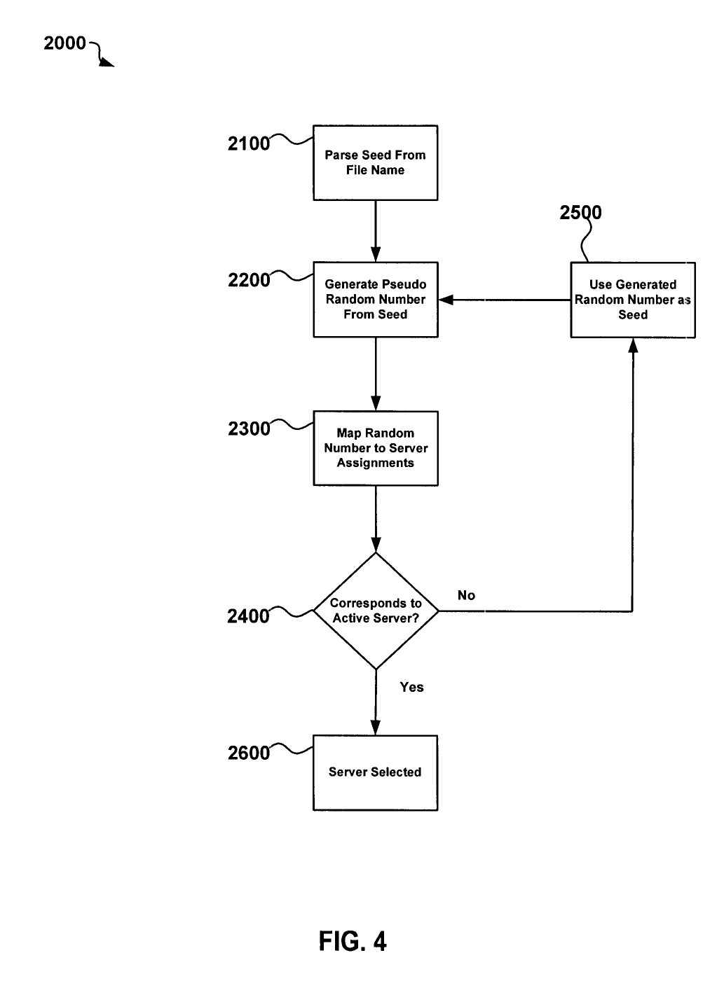

In one embodiment, upon receiving a request for a file, a gateway server locates a server to service the request using the method 2000 illustrated in FIG. 4. A seed number is parsed from the requested file's name 2100, which could be a number taken literally from the file name, could be an integer value based on the characters within the file name, or can be any other number which can be deterministically derived from the file name. The seed is then used to generate a pseudo-random number 2200 using a pseudo-random number generator that reproducibly outputs the same number for a given seed number.

The random number is then mapped 2300 to the existing server assignments, using, for example, a server map such as that shown in FIG. 3. If the random number corresponds to an active server 2400, that server is selected to service the request 2600. If the random number corresponds to blank portion of the range (a segment not assigned to an active server), the generated random number is used as a seed 2500 for the pseudo-random number generator 2200. The process continues to loop until an active server is identified.

The average number of calls to the pseudo-random number generator necessary to find a non-blank part of the unit interval is inverse to the fraction of the range that is covered by all media servers. If only one-fourth of the range is covered (as in FIG. 3), the pseudo-random number generator will need to be called four times on average before finding an eligible server. If the mapping of media servers covers only 1% of the unit interval, then the gateway will have to generate an average of 100 pseudo-random numbers to distribute one request. Nevertheless, even in the case where only 1% of the unit interval is covered, such a method causes negligible latency or overhead since linear congruence generators are relatively simple and execute very rapidly.

In one embodiment, a stateless addressing method can additionally be implemented such that as few files as possible are re-addressed to different servers when a media server leaves or joins the media server pool. In one embodiment, files assigned to a server leaving the pool are the only files reassigned to other servers. For example, filename ABCD which is served by server #6, should not be reassigned to server #7 because server #15 left or joined the server pool. Such a result can be achieved by implementing a rule such that when a server leaves the server pool, no portion of the segment of the unit interval the departing server was assigned to is reassigned to another server, nor are the segments assigned to any other server modified.

The pseudo-random number generator and the server mapping function can be executed, as in FIG. 4, until an active server is located. Thus, when the server exits the server pool, the stateless addressing method will automatically select new servers to service requests for files normally serviced by that server. If the server re-enters the pool, the server will be automatically selected for files within its assigned portion of the unit interval. Unless the server lost has its cache, the server will also likely have the files for which it is responsible in its cache, hence, disruption is minimized.

In one embodiment, a stateless addressing method can substantially balance transmission loads among servers within a server pool by partitioning filenames between servers in a manner substantially proportional to weights assigned to individual media servers within the pool. For example, a newer server can have twice the capacity of an older server, and therefore should serve twice as large a portion of the content library as the older server. In one embodiment, such a result can be substantially realized by setting the length of the segment of the unit interval assigned to a server in proportion to that server's weight. For example, referring back to FIG. 3, media server 360b has twice the capacity of either server 360c or 360d, and is thus, server 360e is assigned a segment which is twice as large as server 360a or 360e.

In such an embodiment, a server's weight can be changed with minimal disruption by lengthening the segment of the unit interval which it is assigned. For example, changing a server's weight from, for example, +2,000 to +2,500 creates only as much disruption as adding a new server of weight +500, i.e. the absolute minimum disruption necessary to respect the new weights. In the event a server is added to a pool after an interval is entirely mapped, all existing segments can be reduced to some fraction of their original size.

A special challenge is presented by very popular files (“hot files”). The number of requests received for a hot file can be sufficient to overwhelm the capacity of a single media server. In one embodiment, files beyond a fixed popularity threshold can be treated as an exception to a stateless addressing method and be evenly distributed between all media servers. In another embodiment, a stateless addressing method can distribute popular streams to the number of servers necessary to meet demand by outputting a consistent server list.

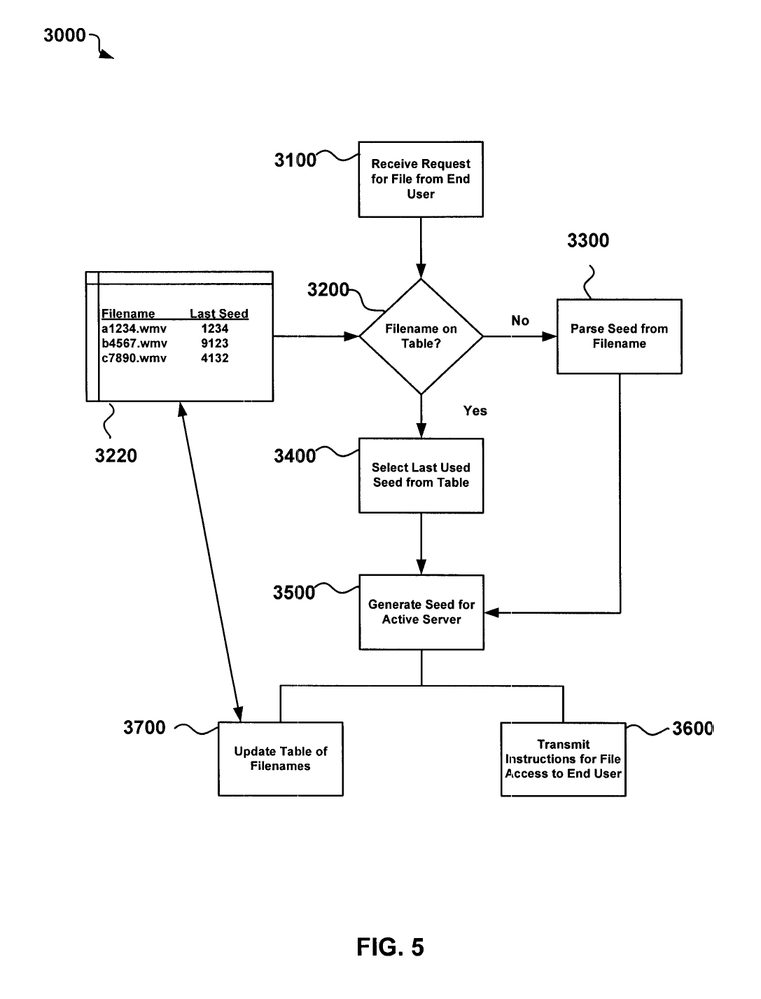

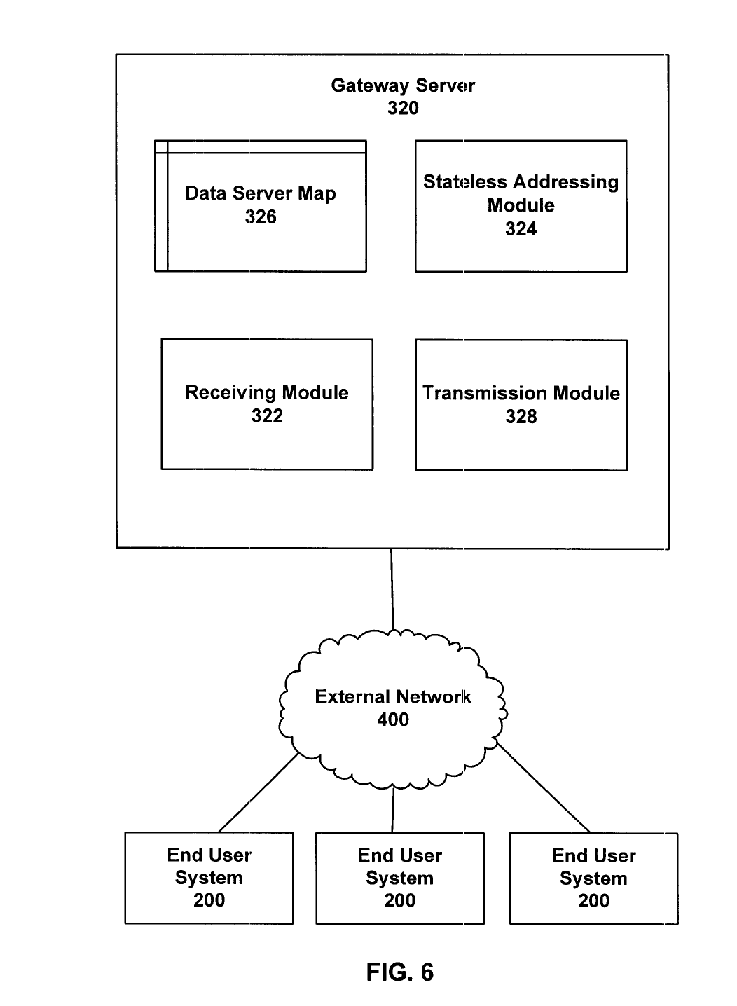

In one embodiment, a gateway server can output a consistent server list for popular files using the method 3000 illustrated in FIG. 5. When a gateway server receives a request for a file 3100 from an end user, the server determines if a request for the same file has been recently received 3200 by checking a table 3220 of recently requested filenames. The table of recently used filenames additionally contains a seed value for each filename, where the seed value is the last seed value used to select a media server for that filename. If there is no entry in the table for the file, an initial seed value is generated using some consistently repeatable criteria 3300, such as, for example, parsing a number out of the filename. If there is an entry in the table for the filename, the seed associated with the filename is selected 3400.

The generated or selected seed is then input into a method 3500 for generating a seed for a pseudo random number that maps to an active server. The method 3500 can be similar to, or identical to that illustrated in FIG. 3. Instructions for accessing the requested content on the selected server are returned 3600 to the requesting end user. The seed corresponding to the selected server and the associated filename is used 3700 to update the table of recently requested filenames 3220. Where no entry exists for the filename, an entry is inserted. Where an entry exists for a filename, the seed value on the table is updated with the most recently used seed.

In one embodiment, a separate process 3800 periodically purges all entries in the table after some time interval T elapses. In another embodiment, the process 3800 continuously purges entries that were created more than some time interval T in the past. Using the method illustrated in FIG. 5, a stream requested N times within the interval T will be distributed to a consistent list of 1 to N servers (since the pseudo-random number generator can select the same server more than once.) Every time the saved seeds are thrown away, the pseudo-random sequence starts over from the filename. If a file is never popular enough to be requested twice within T, the filename will always be used as the seed, and thus it will always be distributed to the same server.

The parameter T can be used to implement a linear sliding scale of popularity based on the size of the media server pool. For example, a higher value for T can be used for a large pool of media server so that moderately popular files can be handled by two or three servers. A very high value for T will cause all requests to be distributed substantially uniformly throughout the entire pool. The gateway server can additionally receive load feedback from media servers and treat an overloaded server as temporarily unavailable. All requests to the overloaded server are then temporarily partitioned among the rest of the pool.

FIG. 6 illustrates one embodiment of a gateway server 320 capable of carrying out the methods disclosed above. The gateway server is accessible to end user systems 200 through an external network 400, for example, the Internet. A receiving module 322 receives requests from the end user systems for delivery of at least a portion of a content library to the end user. After receiving a request for data from the end user, a stateless addressing module 324 selects a data server to deliver data to the end user using a stateless addressing method which, in one embodiment, utilizes a data server map 326. After a data server is selected, a transmission module 328 transmits instructions to the end user system 200 to enable the end user system to issue a second request to the selected data servers for delivery of the requested data.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A system comprising:
a library of data stored on a storage device;
a plurality of data servers, each data server being operatively connected to the storage device and to an end user;
at least one gateway server operatively connected to an end user comprising
a receiving module that receives a first request from the end user for delivery of at least a portion of the library of data to the end user,
a stateless addressing module that selects one of the plurality of data servers to deliver the at least a portion of the library of data to the end user using a stateless addressing method, and
a transmission module that transmit instructions to the end user to enable the end user to issue a second request to the selected one of the plurality of data servers for delivery of the at least a portion of the library of data to the end user.

2. The system of claim 1 further comprising wherein the stateless addressing module selects one of the plurality of data servers by generating a pseudo-random number using a seed generated using at least one property of the at least a portion of the library of data.

3. The system of claim 2 further comprising wherein the gateway server further comprises a data server map wherein each of the plurality of data servers is assigned to a continuous, non-overlapping segment of the data server map and the stateless addressing module uses the pseudo-random number to select a point within the data server map, wherein if the point is within a segment of the data server map assigned to one of the plurality of data servers, the data server is selected.

4. The system of claim 3 further comprising wherein the data server map is configured such that the size of the non-overlapping segments of the data server map assigned to each of the plurality of data servers is proportional to each server's capacity.

5. The system of claim 3 further comprising wherein if the point is not within a segment assigned to one of the plurality of data servers, the stateless addressing module continues to generate pseudo-random numbers until a pseudo-random number falls within a within a segment of the data server map assigned to one of the plurality of data servers.

6. The system of claim 2 further comprising wherein the at least a portion of the library of data is a file, and the seed is generated by the stateless addressing module using a number parsed out of the file name.

7. The system of claim 2 further comprising wherein the stateless addressing module does not reuse any seed generated for a specific instance of the at least a portion of the library of data and used to select one of the plurality of data servers for some time interval T.

8. A method comprising the steps:
receiving a request from an end user for delivery of at least a portion of a library of data;
selecting one of a plurality of data servers using a stateless addressing method;
transmitting the at least a portion of the library of data to the end user from the selected one of a plurality of data servers.

9. The method of claim 8, wherein the stateless addressing method comprises the steps of:
mapping each of the plurality of data servers to a continuous, non-overlapping segment of a data server map;
generating a seed using at least one property of the at least a portion of the library of data;
generating a pseudo-random number using the seed; and
selecting the data server mapped to the portion of the data server map which contains the pseudo-random number.

10. The method of claim 9, wherein if the pseudo-random number is located within a portion of the data server map that is not assigned to a one of the plurality of data servers, a second pseudo-random number is generated and used to select the data server mapped to the portion of the data server map which contains the second pseudo-random number.

11. The method of claim 9, wherein the wherein the size of the non-overlapping segments of the data server map assigned to each of the plurality of data servers is proportional to each server's capacity.

12. The method of claim 9, wherein the at least a portion of the library of data is a file and the seed is a number parsed out of the file name.

13. The method of claim 8, wherein the stateless addressing method comprises the steps of:
mapping each of the plurality of data servers to a continuous, non-overlapping segment of a data server map;
generating a seed using at least one property of the at least a portion of the library of data;
determining if the seed has been previously used within some time interval T to select a data server to deliver the at least a portion of the library of data to an end user;
regenerating the seed if the seed has been previously used within some time interval T to select a data server to deliver the at least a portion of the library of data to an end user;
generating a pseudo-random number using the seed; and
selecting the data server mapped to the portion of the data server map which contains the pseudo-random number.

14. A computer-readable medium having computer-executable instructions for a method comprising the steps:
receiving a request from the end user for delivery of at least a portion of the library of data;
selecting one of a plurality of data servers to deliver the at least a portion of a library of data using a stateless addressing method;
transmitting the at least a portion of the library of data to the end user.

15. The computer-readable medium of claim 14, wherein the stateless addressing method comprises the steps of:
mapping each of the plurality of data servers, to a continuous, non-overlapping segment of a data server map;
generating a seed using at least one property of the at least a portion of the library of data;
generating a pseudo-random number using the seed; and
selecting the data server mapped to the portion of the data server map which contains the pseudo-random number.

16. The computer-readable medium of claim 15, wherein if the pseudo-random number is located within a portion of the data server map that is not assigned to a one of the plurality of data servers, a second pseudo-random number is generated and used to select the data server mapped to the portion of the data server map which contains the second pseudo-random number.

17. The computer-readable medium of claim 15, wherein the wherein the size of the non-overlapping segments of the data server map assigned to each of the plurality of data servers is proportional to each server's capacity.

18. The computer-readable medium of claim 15, wherein the at least a portion of the library of data is a file and the seed is a number parsed out of the file name.

19. The computer-readable medium of claim 14, wherein the stateless addressing method comprises the steps of:
mapping each of the plurality of data servers to a continuous, non-overlapping segment of a data server map;
generating a seed using at least one property of the at least a portion of the library of data;
determining if the seed has been previously used within some time interval T to select a data server to deliver the at least a portion of the library of data to an end user;
regenerating the seed if the seed has been previously used within some time interval T to select a data server to deliver the at least a portion of the library of data to an end user;
generating a pseudo-random number using the seed; and
selecting the data server mapped to the portion of the data server map which contains the pseudo-random number.
